(19) United States
(12) Patent Application Publication
(10) Pub. No.: US 2023/0342764 A1
(43) Pub. Date: Oct. 26, 2023

(54) DIGITAL BLOCKCHAIN VOTING TECHNOLOGY SYSTEM AND METHOD

(71) Applicant: Todd White, Farmington Hills (UA)

(72) Inventor: Todd White, Farmington Hills (UA)

(21) Appl. No.: 17/963,518

(22) Filed: Oct. 11, 2022

Related U.S. Application Data
(60) Provisional application No. 63/333,060, filed on Apr. 20, 2022.

(51) Int. Cl. G06Q 20/38; G06Q 20/36

(52) U.S. Cl. CPC G06Q 20/389; G06Q 20/3678; G06Q 2230/00

(57) ABSTRACT

A digital blockchain voting technology system is provided. The system comprises a computer and an application stored in the computer. When executed, the application receives a first message that an administrative wallet has received funds via a blockchain. The system also determines that the funds were sent by a donor wallet associated the blockchain. The system also receives a second message from a user device associated with the donor wallet, the second message requesting disbursement of the funds. The system also disburses the funds in accordance with an allocation formula provided by the user device. The funds are directed, based on the allocation formula, to at least one legislative wallet associated with at least one legislator, the at least one legislative wallet associated with the blockchain. The allocation formula prescribes disbursements of the funds by stated percentages of the funds to stated legislators.

### CROSS REFERENCE TO RELATED APPLICATIONS

The present non-provisional patent application is related to U.S. Provisional Patent Application No. 63/333,060 filed Sep. 24, 2022, the contents of which are incorporate herein in their entirety.

### FIELD OF THE DISCLOSURE

The present disclosure is in the field of tracking and measuring political donations and fundraising and insuring integrity thereof. More particularly, the present disclosure provides for searching for legislation of interest and associated legislators and making political donations of digital currency to the legislators via blockchain with information describing donor transactions stored securely in the blockchain and reportable to federal agencies in accordance with regulations.

### BACKGROUND

Campaign finance, political fundraising, and donor activities are receiving increasing attention as stakes are high and amounts of money involved become staggering. Large companies and wealthy persons devote millions to influence legislators to adopt or block legislation. They may turn to lobbying federal agencies that are issuing regulations. They may also approach judges in the courts to block those regulations from taking effect. Candidates and elected officials often spend hours and hours a day doing “call time” with large donors. They attend private, closed-door fundraising events hosted by wealthy donors. Politicians court lobbyists and other influential persons who can open the doors to thousands of dollars in PAC contributions or millions in super PAC spending.

All of this activity is legal. The US Supreme Court has struck down many efforts to remove big money from politics. Since the Citizens United decision in 2010, outside groups have more than tripled their spending on political campaigns. During the 2016 election alone, outside organizations spent a $1.4 billion on elections, and nearly $181 million of those funds remain untraceable because they were spent by dark money organizations. Dark money refers to political spending by nonprofit organization, for example, 501 501 and 501 groups, that are not required to disclose their donors. Such organizations can receive unlimited donations from corporations, individuals and unions.

The American public has expressed concerns for years about integrity of political donations. Previous implementations have attempted to introduce controls to support such integrity.

### SUMMARY

The present disclosure teaches systems and methods of making lawful and secure political donations based on the following:
(a) Utilizing digital currencies for political contributions that are made via uploading onto a blockchain/distributed ledger. A donor transfers funds from their wallet to an administrator or admin wallet through an EOS blockchain. The donor then logs in to a web application to allocate the funds to specific legislators. The admin transfers the funds to the legislator EOS wallet based on allocation specified by the donor.
(b) The blockchain voting technology (BVT) is an all-in-one system enabling a prospective donor (corporate or individual) to search and determine the status of an item of legislation and determine who voted and how they voted.
(c) Search tools provided by the system are based in part on artificial intelligence to search for legislation on specific issues and associated legislators. A donor may access standard queries or construct custom queries to search public application programming interfaces (API) and other sources for information about issues, related legislation, voting results, and associated legislators and other relevant parties.
(d) A donor may make political contributions within the blockchain digital voting technology system directly to a legislator's candidate committee. The contribution is again uploaded onto the blockchain. The donor may transfer funds to an admin EOS wallet through any crypto wallet/exchange that has EOS crypto chain network support to the admin wallet. The admin wallet will then transfer the allocated funds to a member EOS wallet of the legislator in accordance with the donor's allocation directives.
(e) The system features automatic Know Your Contributor/Anti Money-Laundering (AML/KYC) functionality to prevent non-us residents from compromising election integrity.
(f) Contribution information is populated into files with at least name, address, state, and occupation of the donor. This information is submitted to the Federal Election Committee and other agencies that may require such information.
(g) The system may charge a fee (for example 9%) on contributions. The fee is calculated and deducted in a separate ledger utilized to maintain costs of the system.
(h) The system may be used along with information provided by political action committees (PAC), government affairs firms, private investigators, and others.

### BRIEF DESCRIPTION OF THE FIGURES

FIG. 1 is a block diagram of a system of blockchain voting technology according to an embodiment of the present disclosure.

FIG. 2 is a diagram of a process flow of blockchain voting technology according to an embodiment of the present disclosure.

FIG. 3 is a diagram of a process flow of blockchain voting technology according to an embodiment of the present disclosure.

FIG. 4 is a diagram of a process flow of blockchain voting technology according to an embodiment of the present disclosure.

FIG. 5 is a diagram of a process flow of blockchain voting technology according to an embodiment of the present disclosure.

FIG. 6 is a listing of software objects of blockchain voting technology according to an embodiment of the present disclosure.

FIG. 7 is an image of a user screen of the application according to an embodiment of the present disclosure.

FIG. 8 is an image of a user screen of the application according to an embodiment of the present disclosure.

FIG. 9 is an image of a user screen of the application according to an embodiment of the present disclosure.

FIG. 10 is an image of a user screen of the application according to an embodiment of the present disclosure.

FIG. 11a and FIG. 11b are images of a combined user screen of the application according to an embodiment of the present disclosure.

FIG. 12a and FIG. 12b are images of a combined user screen of the application according to an embodiment of the present disclosure.

FIG. 13 is an image of a user screen of the application according to an embodiment of the present disclosure.

FIG. 14 is an image of a user screen of the application according to an embodiment of the present disclosure.

FIG. 15 is an image of a user screen of the application according to an embodiment of the present disclosure.

FIG. 16a and FIG. 16b are images of a combined user screen of the application according to an embodiment of the present disclosure.

FIG. 17 is an image of a user screen of the application according to an embodiment of the present disclosure.

FIG. 18 is an image of a user screen of the application according to an embodiment of the present disclosure.

FIG. 19a and FIG. 19b are images of a combined user screen of the application according to an embodiment of the present disclosure.

FIG. 20 is an image of a user screen of the application according to an embodiment of the present disclosure.

FIG. 21 is an image of a user screen of the application according to an embodiment of the present disclosure.

FIG. 22 is a flow diagram of the application according to an embodiment of the present disclosure.

FIG. 23 is an image of a user screen of the application according to an embodiment of the present disclosure.

FIG. 24 is an image of a user screen of the application according to an embodiment of the present disclosure.

FIG. 25 is an image of a user screen of the application according to an embodiment of the present disclosure.

FIG. 26 is a listing of computer instructions executed by the application according to an embodiment of the present disclosure.

### DETAILED DESCRIPTION

Systems and methods described herein provide for a political donor to search for an locate names of legislators associated with particular items of legislation and make donations via a blockchain to those legislators. A blockchain voting technology application is provided herein that searches for legislation of interest that may be currently pending or have already received at least one vote. A donor, via an electronic donor wallet and via a blockchain based on the EOS protocol and cryptocurrency, may send digital currency to all or selected legislators associated with an item of legislation of interest to the donor. The application collects political contributions from donors through wallet-to-wallet transfers of digital currency and securely transmits the donated funds to designated recipient legislators.

Initially, an administrator wallet or admin wallet on the blockchain receives donated funds via the blockchain from the donor wallet. The admin wallet disburses the funds according to allocation instructions provided by the donor wallet. The disbursement may be in varying amounts to each legislator designated by the donor as a recipient. A donor in an example making a contribution to seven legislators may fractionalize the contribution by directing that 25% of the total contribution be given to each of two legislators and that 10% of the total amount be given to each of the other five legislators. The admin wallet handles this processing and disbursement.

Information describing donations and other transactions is stored in the blockchain. This information is used in part to create reports about political contributions and campaign finance that may be requested or required by governmental bodies or other entities. The immutable ledger of the blockchain supports assurance about the integrity of the information.

Further, the structure of the blockchain, including the use of donor and admin wallets, and the manner in which political donations are submitted, received, fractionalized, and disbursed are designed to be in compliance with guidelines and regulations surrounding such activities. Compliance with KYC/AML is reinforced by the structure and controls built into the system. Such compliance may support efforts to prevent non-US parties from influencing US elections.

Political donors may obtain the services provided herein by accessing the application via user devices running browser software. The application may be a web application or otherwise Internet-based. Via the application, donors may access donor wallets on the blockchain and submit digital contributions from the wallets.

User devices do not necessarily correspond to donor wallets on a one-to-one basis. User devices may typically represent individual users or donors while a single donor wallet may represent a group of donors with a single cause or specific interest. In an embodiment, a donor wallet may be created for a single item of legislation, a body of legislation, or an overall cause involving multiple legislatures and jurisdictions over an extended period. The wallet may eventually be deleted or made inactive after the legislation has received passage, been voted down, or ceases to be important.

The blockchain voting application also has an administrator function with oversight duties over many network administration functions but also with responsibilities to control at least one admin wallet on the EOS blockchain. The admin wallet creates and deletes donor wallets and manages transactions including inserting immutable records into the blockchain through which political contributions pass. Contributions from donor wallets are initially received into the admin wallet. The admin records information about the contributions in the blockchain and handles disbursements of the contributions to legislator wallets.

Persons serving in the administrator function for the blockchain voting application may not be the same person or parties who control the admin wallet on the blockchain. The application with its client devices and administrator device is separate from the blockchain with its admin wallet, donor wallets, and legislator wallets.

The application is one but not the only means of access to donor wallets. In embodiments, donors may access donor wallets through means other than the application given they have met security requirements. But most or all persons or parties seeking to access a donor wallet and make contributions at some point must register and authenticate with the application that controls key aspects of blockchain access and operation.

The system also provides significant search functionality for an interested party to search for legislation surrounding an issue of interest as well as the identities of legislators involved in the laws. Political contributors are often interested in certain issues that are directly or indirectly addressed by pending items in front of a legislative body such as an assembly or congress of elected representatives or in some cases non-elected persons.

The application uses artificial intelligence to search for legislation associated with specific issues of interest to prospective donors. A user may submit search arguments or other query terms associated with issues of interest and receive listings of legislation related to the issues. The legislation may be ongoing in more than one legislative chamber or body for various jurisdictions such as cities, counties, provinces, and at a national level, even supranational in the case of legislation in front of the United Nations, for example.

The user, as with many database and other searches, may delimit his/her search by entering specific jurisdictions, date or calendar ranges, and legislation status, for example pending, passed, or voted down. If the user knows the name of a specific legislator involved in legislation of interest but does not know the name or number of the legislation, the user may search based on known terms.

In searching for legislation, names of legislators, or other information related to pending issues, the system may search numerous public and private databases as well as other repositories of information including journalistic items and scholarly material.

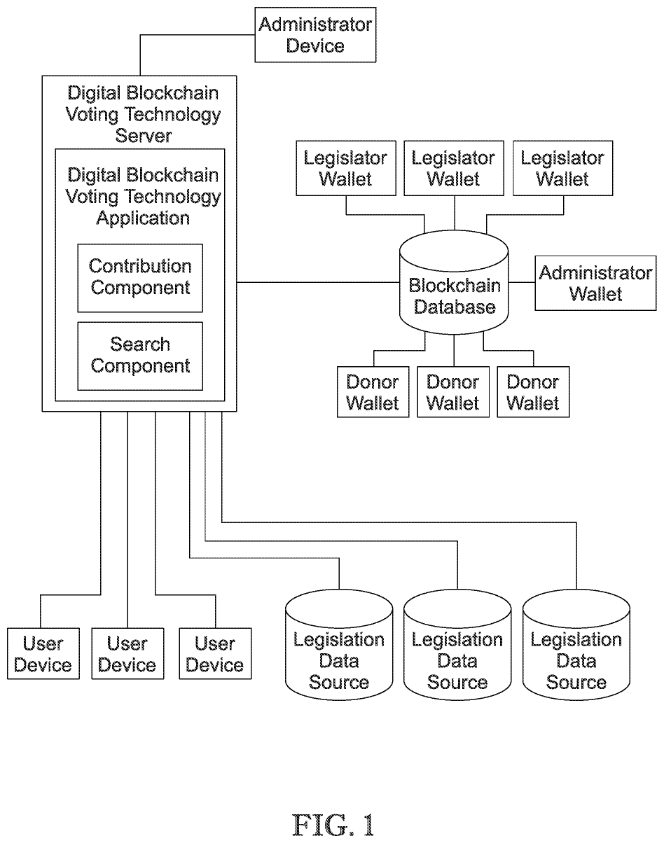

Turning to the figures, FIG. 1 is a block diagram of a system of digital blockchain voting technology according to an embodiment of the present disclosure. FIG. 1 depicts components and interactions of a system 100 according to an embodiment.

The system 100 comprises a digital blockchain voting technology server 102 and a digital blockchain voting technology application 104, referred to hereinafter respectively for brevity as the server 102 and the application 104. The system 100 also comprises a contribution component 106, a search component 108, an administrator device 110 and user devices 112a-c.

The system 100 also comprises a blockchain database 114, an administrator wallet 116, donor wallets 118a-c, and legislator wallets 120a-c. The system 100 also comprises legislation data sources 122a-c.

While the system 100 comprises and FIG. 1 depicts quantity three of each of user devices 112a-c, donor wallets 118a-c, legislator wallets 120a-c, and legislation data sources 122a-c, this quantity is for discussion and illustration purposes only. In embodiments, systems and methods comprise more than or less than quantity three of each of these components.

The application 104 may be a web application and executes fully or partially on the server 102 which may be one or more physical computers situated at more than one geographic location. The application 104 may in embodiments be more than one software application.

The contribution component 106 is a software component of the application 104 and handles most of the functionality described herein related to assisting contributors comprising natural persons and other entities seeking to make political contributions to legislators of digital currency. The contribution component 106 controls functionality to determine that a prospective contributor is legally authorized to make contributions and therefore be associated with a donor wallet 118a-c. The contribution component 106 may provide the contributor with access to an existing donor wallet 118a-c for a contributor or assist in creating a new donor wallet 118a-c for the contributor if need be.

The contribution component 106 also handles activities for assuring KYC/AML compliance and may generate information toward the creation of reports requested or required by government bodies or others. The contribution component 106 may be involved in audits performed both internally and by outside parties to assure such compliance with KYC/AML guidelines as well as with campaign finance laws and other laws.

The search component 108 handles database searching and other search activities when a donor or other party seeks to identify legislation and legislators associated with a given issue. The search component 108 has a considerable artificial intelligence component to search for legislation that may be pending, passed, or of other status in potentially multiple legislative bodies in potentially multiple jurisdictions.

An interested party may submit very basic search arguments such as “abortion” or “gun control” and the search component 108 would understandably produce results comprising many legislatures and many individual lawmakers, most likely too many to contribute to in a single contribution. The search component 108 enables a party to narrow a search by entering delimiters such as location or type of legislator and time frame in which legislation of interest is subject to vote.

The contribution component 106 searches for legislation of interest based on submitted issues but may also find legislation when a user submits names of legislators or other search arguments instead of issues. The user may wish to locate only those legislators who voted in a certain member or only legislators who are members of a political party.

The administrator device 112 is a computer or other electronic device used by a person or parties with administrative authority over the application 104 and other elements of the system 100. The administrator device 112 oversees the operations of the system 100 including approving donors to access donor wallets 118a-c and make contributions, receiving contributions into the admin wallet 116, segmenting contributions via allocation directives if any, and distributing contributions to legislator devices 120a-c.

Via the application 104 and the contribution component 106, the administrator device 112 observes that digital funds have arrived in the admin wallet 110 with instructions to direct the funds to legislators associated with a particular item of legislation that recently passed in a legislature. For example, if the donor cannot name the specific legislation, the legislature, or the legislators, the administrator device 112 may activate the search 108 to determine this information, assure compliance with KYC/AML, and then release the funds to legislator wallets 120a-c of the legislators. In the example, the donor may not know how many legislators his/her funds will be directed to and only knows that a group of legislators voted in the manner favored by the donor. The administrator may make this determination and disburse the funds accordingly. The administrator also assures that aspects of donor transactions and other transactions are recorded in the immutable ledger of the blockchain 114.

The admin wallet 116, also referred to as the Admin EOS Wallet, receives funds contributed by donor wallets 118a-c. The admin wallet 116 makes determinations about how contributions are to be allocated among multiple legislator wallets 120a-c. The admin wallet 116 in conjunction with the administrator device 112 executes disbursements according to the allocations and assures that transactions are properly recorded in the blockchain 114.

User devices 112a-c are used by donors to access the application 104, activate donor wallets 118a-c, perform searches via the search component 108, and make contributions via their donor wallets 118a-c and the contribution component 106 that eventually are deposited into legislator wallets 120a-c. User devices 112a-c may be mobile devices, laptop computers, desktop computers, or other devices that may host Internet browser software for accessing the application 104.

The legislation data sources 122a-c are databases and other sources of information that may be searched by the search component 108 to determine items of legislation, legislatures, jurisdictions, legislators, and voting records. While the legislation data sources 122a-c are shown as databases in FIG. 1, the legislation data sources 122a-c may not be databases and may be Internet web sites and private sources of data not stored in relational or other databases. The system 100 integrates third party REST APIs for https://www.fec.gov/ to access account details of US senators. The system may also integrate the Internet web site at https://www.govtrack.us/congress/members

The system 100 may integrate third party REST APIs https://api.propublica.org/congress/v1/117 to obtain the US Senate details and https://api.propublica.org/congress/v1/117 to obtain US House of Representatives details. The system 100 integrates third party REST APIs such as https://api.propublica.org/congress/v1/bills to obtain details of legislation.

The system 100 integrates third party REST APIs such as https://api.propublica.org/congress/v1/both/votes to obtain voting details. The system 100 integrates third party REST APIs such as https://eos.greymass.com/v1/history/get actions to obtain information about transactions executed by some donors. The above actions are examples of the system 100 accessing legislation data sources 122a-c.

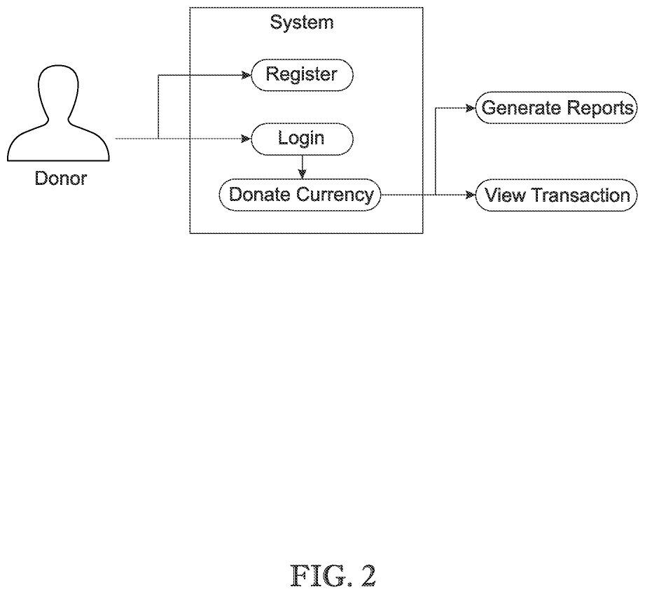

FIG. 2 is a diagram of a process flow of blockchain voting technology according to an embodiment of the present disclosure. FIG. 2 illustrates how a donor may register with the system using a user device 112a-c, log in, access a donor wallet 118a-c, and donate digital currency. Thereafter the donor may generate reports and view transactions.

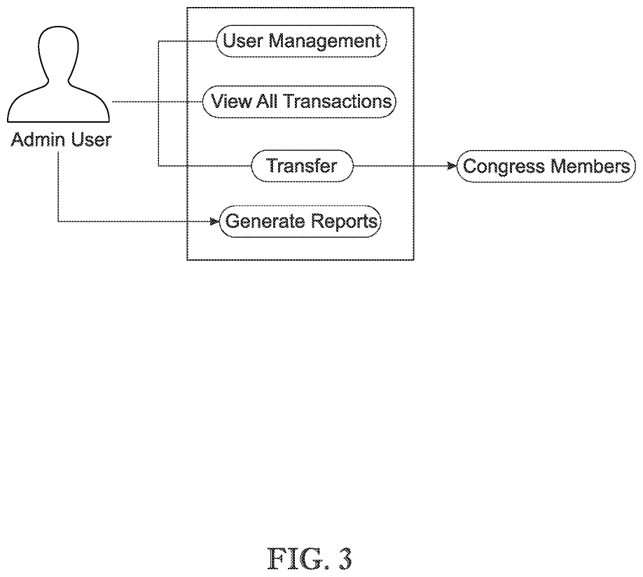

FIG. 3 is a diagram of a process flow of blockchain voting technology according to an embodiment of the present disclosure. FIG. 3 illustrates how an administrative user via the administrative device 110 may access user management tools, view transactions, and generate reports. The administrative user also transfers funds to congress members.

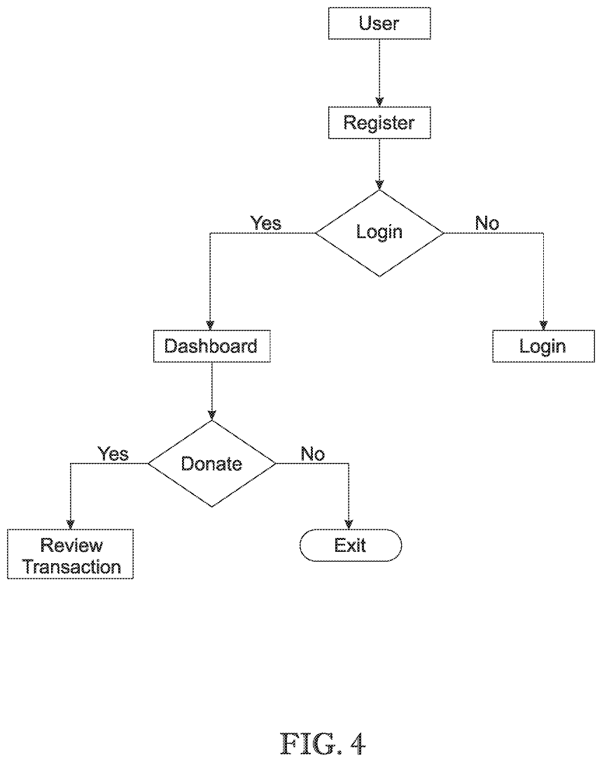

FIG. 4 is a diagram of a process flow of blockchain voting technology according to an embodiment of the present disclosure. FIG. 4 illustrates how a user registers and attempts to log in. If the login is successful the user may access a dashboard, make donations, and thereafter review the transaction.

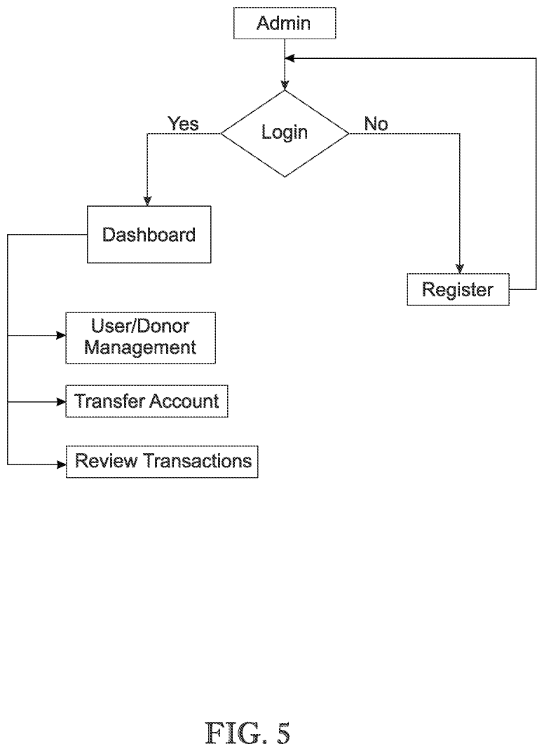

FIG. 5 is a diagram of a process flow of blockchain voting technology according to an embodiment of the present disclosure. FIG. 5 illustrates how an administrative person logs in and accesses a dashboard. From there the admin may review transactions and engage in user/donor management.

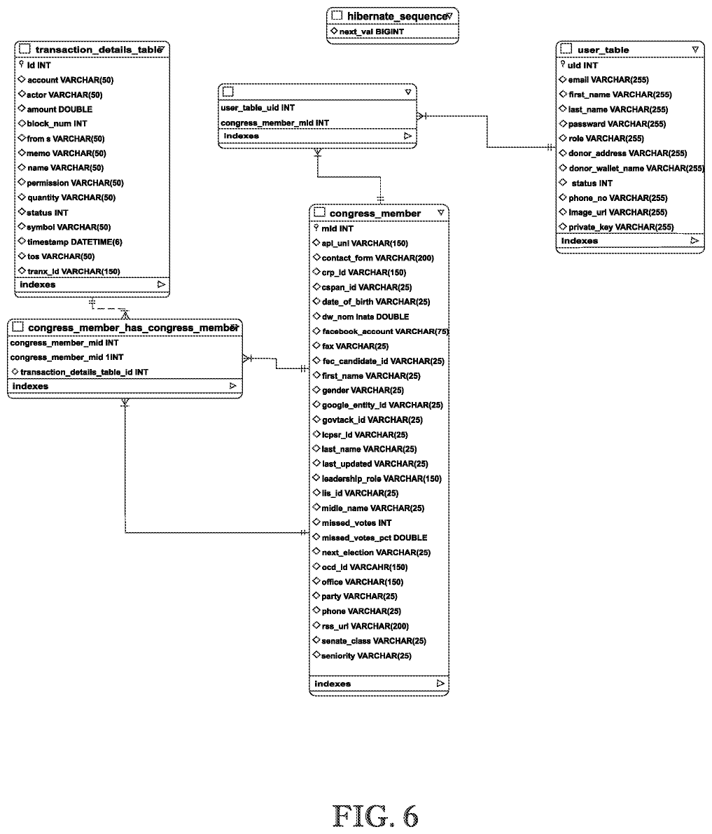

FIG. 6 is a listing of software objects of blockchain voting technology according to an embodiment of the present disclosure.

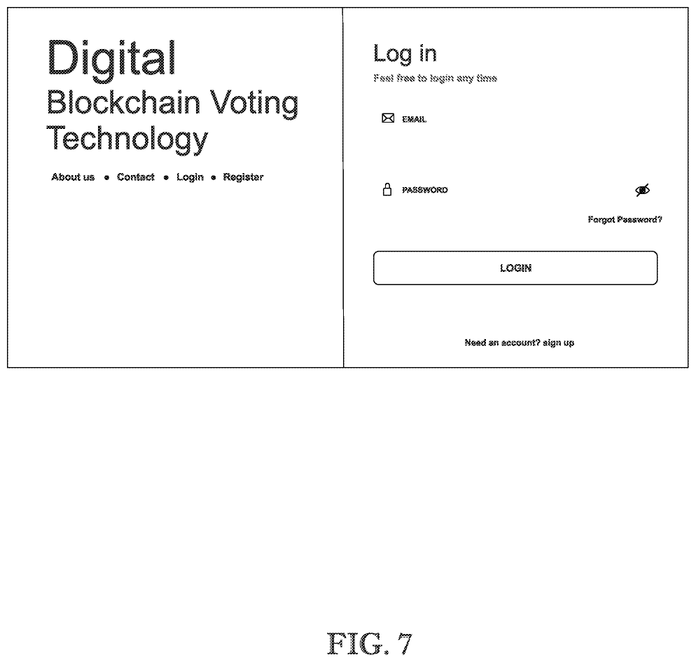

FIG. 7 is an image of a user screen of the application according to an embodiment of the present disclosure. This module will be used to login into the application. This login screen contains field for username and password and has links including About, Contact, and Login\Register.

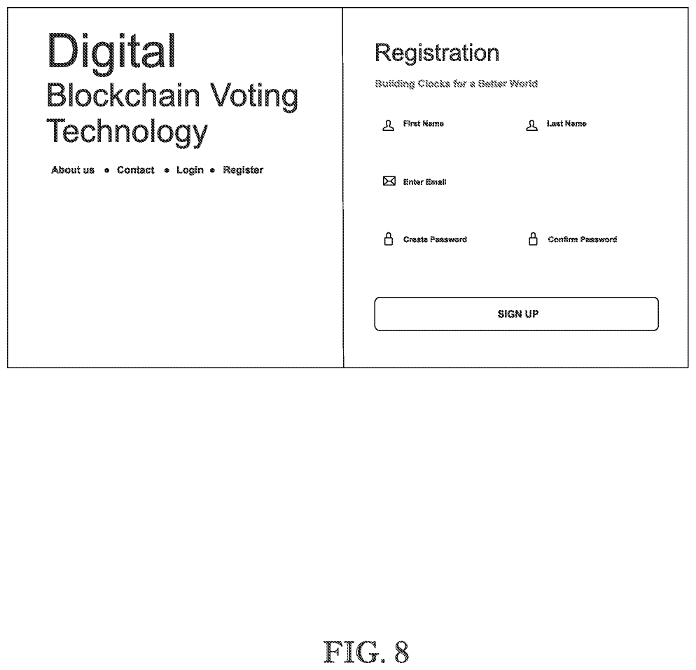

FIG. 8 is an image of a user screen of the application according to an embodiment of the present disclosure. This module will be used for the new user/donor of application needing to register with some information including username, password, and email ID. After registering the donor may login with Email ID and Password into the application.

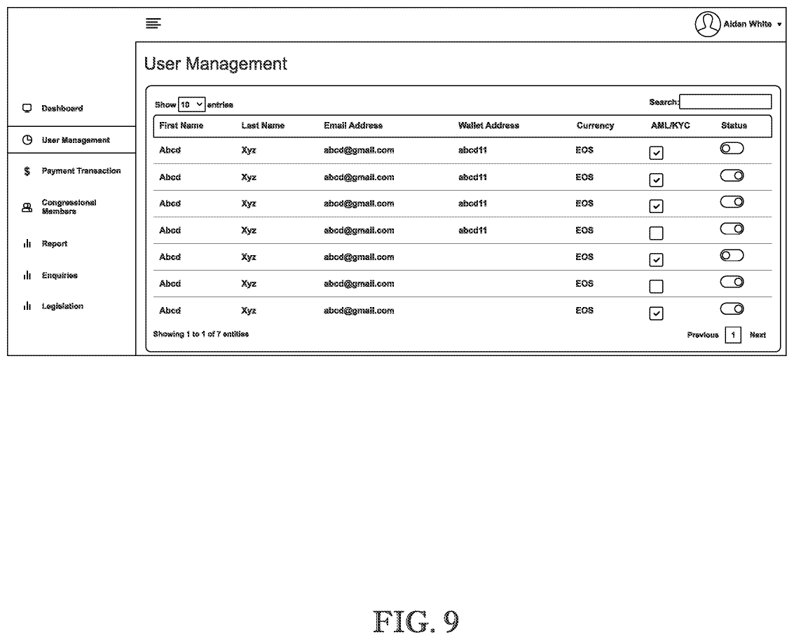

FIG. 9 is an image of a user screen of the application according to an embodiment of the present disclosure. FIG. 9 is a dashboard interface for administrator. A party with administrator privileges may view recent or noteworthy transactions details. The administrator may also view the admin wallet information including like wallet name, wallet balance, total donor, total active donors, total legislature members, total paid amount, total received amount and total pending amount.

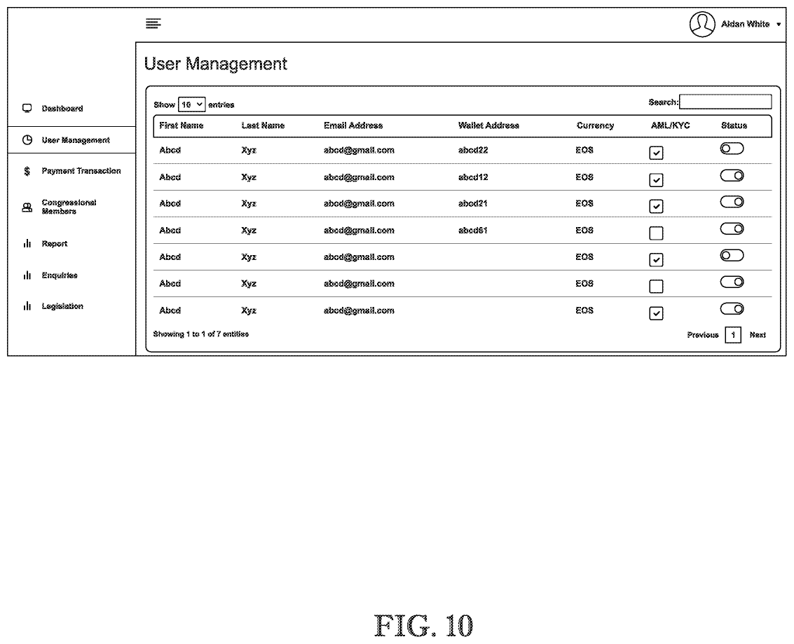

FIG. 10 is an image of a user screen of the application according to an embodiment of the present disclosure. FIG. 10 is a donor/user management interface for administrator. This screen depicts donor information in data table form including first name, last name, Email address, wallet name and status of the donor, for example active or inactive. The administrator has broad powers including authority to change the status of donors and wallet name of the donor.

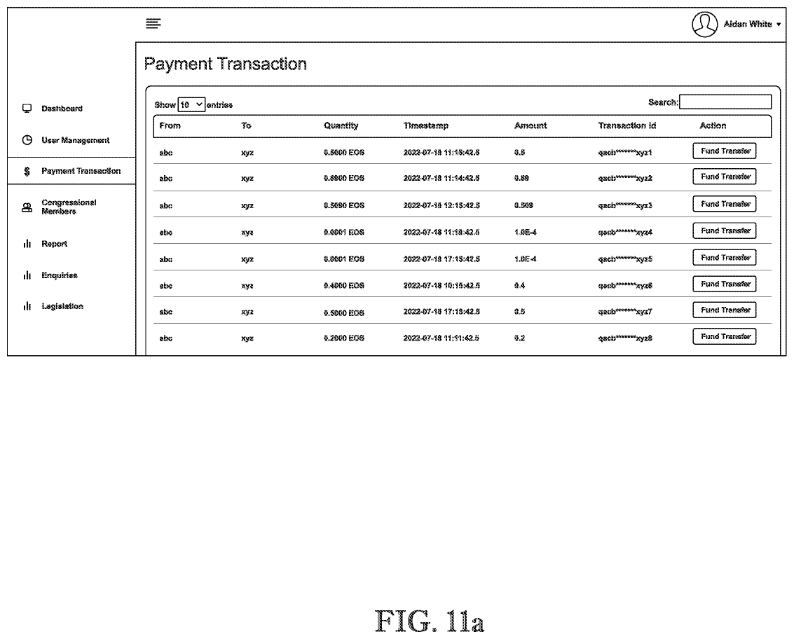

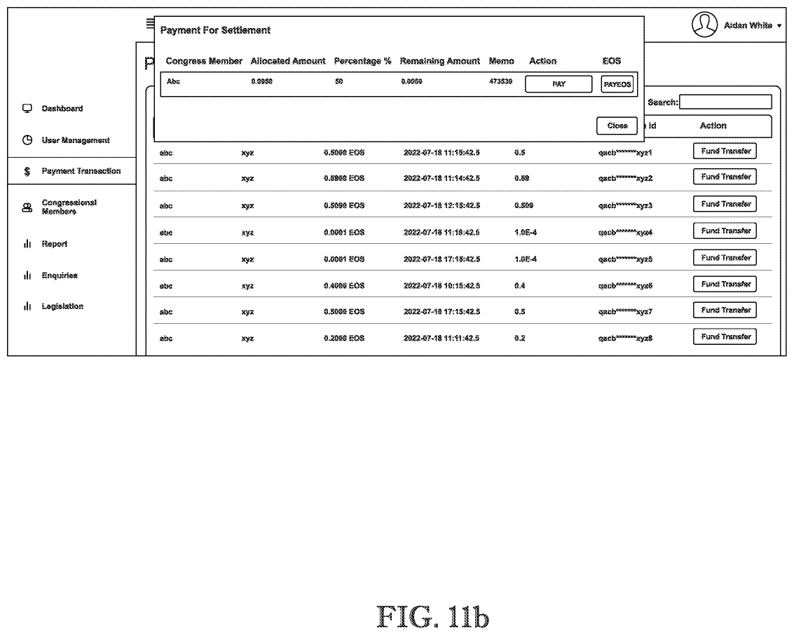

FIG. 11a and FIG. 11b are images of a combined user screen of the application according to an embodiment of the present disclosure. FIG. 11a and FIG. 11b are images of a combined payment transaction management interface for administrator. These screens together depict payment transactions of all the donors with wallet information of the donor including wallet name, transaction ID, and account of the blockchain. In the Payment Transaction tab, the administrator may view incoming and outgoing transactions separately by selecting drop down options such as “Received Transaction” and “Outgoing Transaction.” In the case of Received Transaction, the administrator may view received transactions from the donor side. In the case of Outgoing Transaction, the administrator may view the outgoing transactions, including amounts the administrator transfers to legislator wallets.

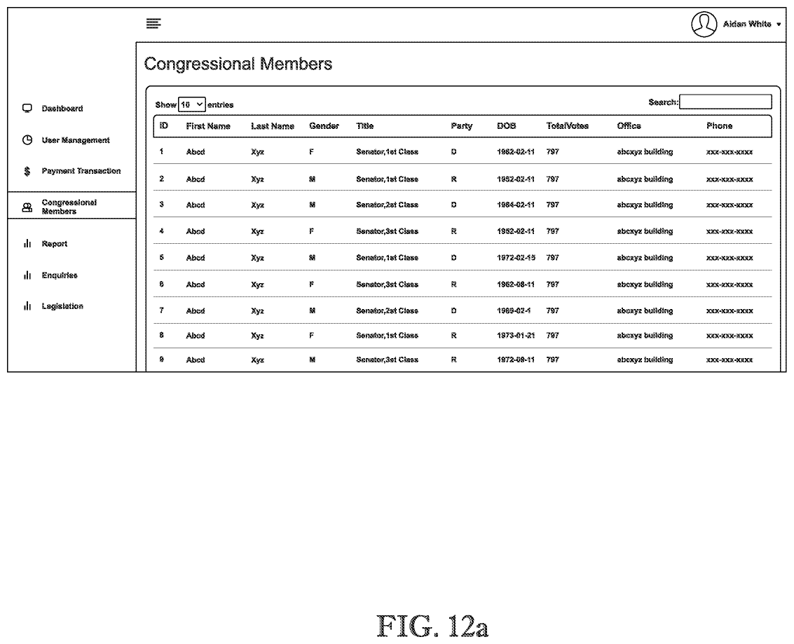

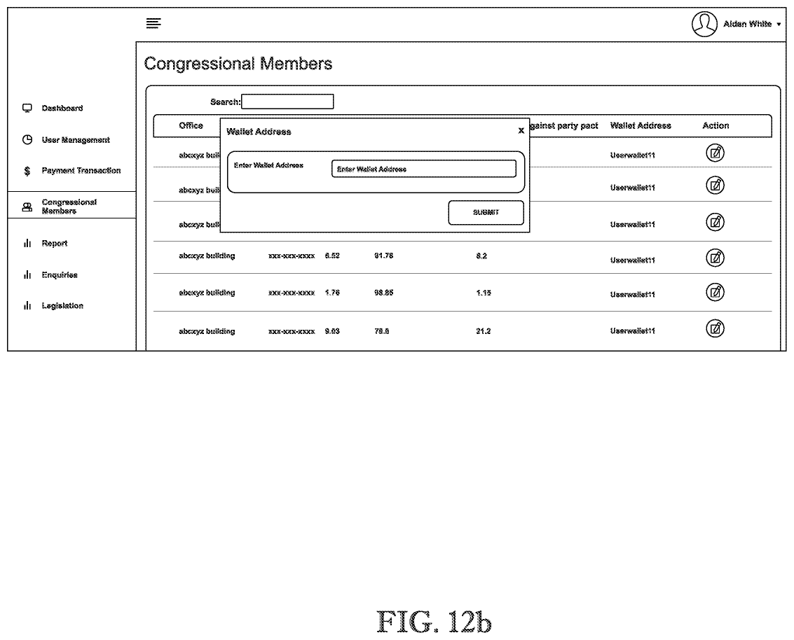

FIG. 12a and FIG. 12b are images of a combined user screen of the application according to an embodiment of the present disclosure. FIG. 12a is a congress member list interface for administrators. This interface depicts a legislator list in data table form including Id, first name, last name, gender, title, party, DOB, total votes, office, phone, missed votes, and votes against party. FIG. 12b updates the wallet address of the legislator to which the administrator transfers fund directly into the legislator wallet.

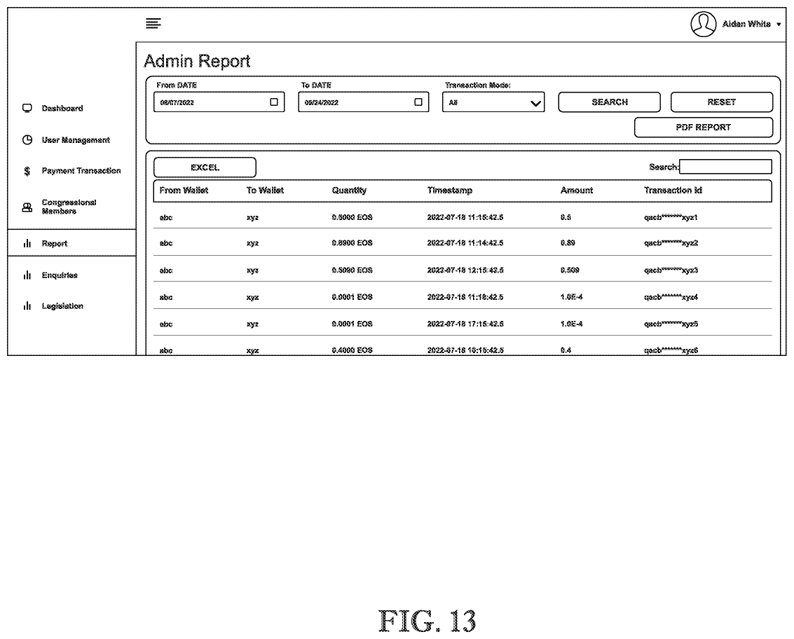

FIG. 13 is an image of a user screen of the application according to an embodiment of the present disclosure. FIG. 13 is a report interface for administrator. This interface fetches report in pdf as well as in spreadsheet format. The administrator may view report data in data table basis using filters such as ‘From Date’, To Date′ and ‘Transaction Mode’ for one or more donors.

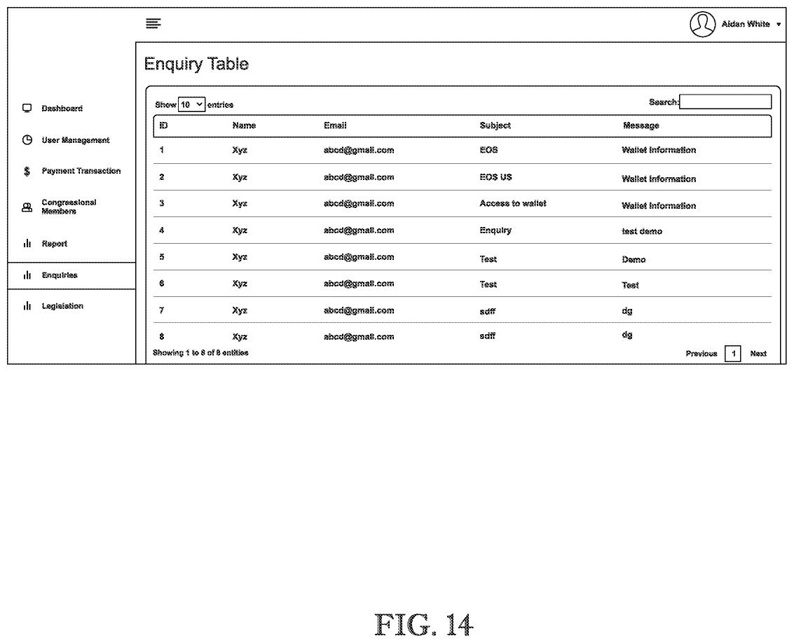

FIG. 14 is an image of a user screen of the application according to an embodiment of the present disclosure. FIG. 14 is an enquiries interface for administrator. The administrator may view complaints raised by the user/donor from ‘contact us’ page with information including ‘Name’, ‘Email’, ‘Subject of the enquiries and ‘Message’.

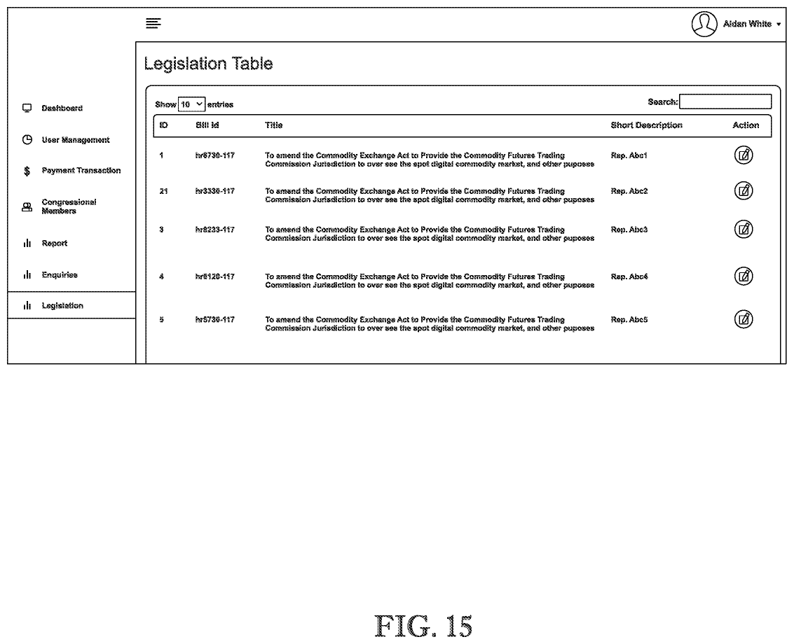

FIG. 15 is an image of a user screen of the application according to an embodiment of the present disclosure. FIG. 15 is a legislation interface for administrator. The administrator may view a legislation list with details including ID, Bill ID, Title, and Short Description based at least on available information about bills and voting data.

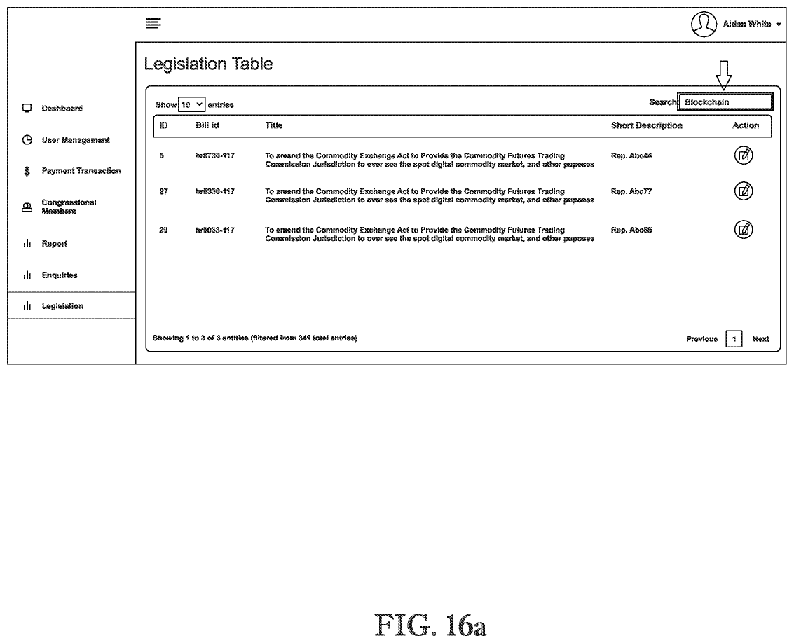

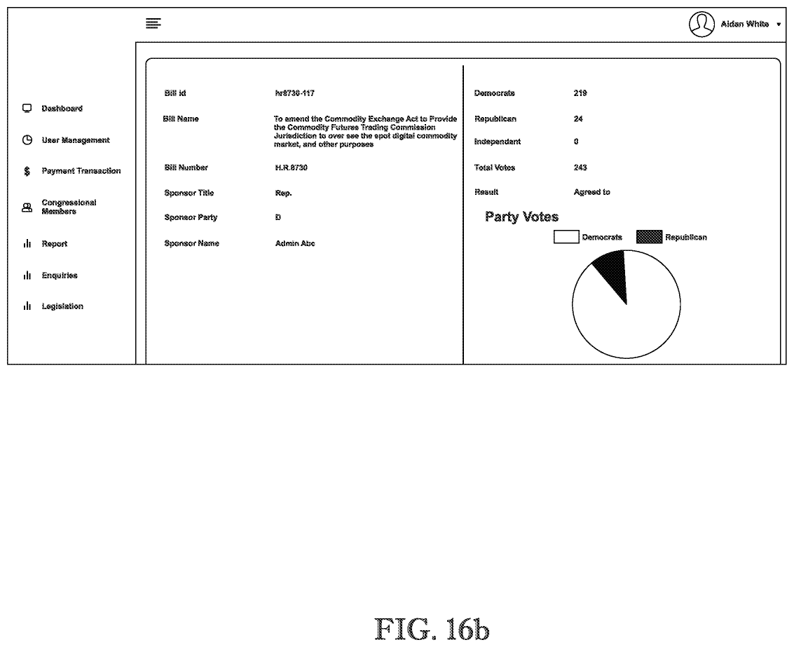

FIG. 16a and FIG. 16b are images of a combined user screen of the application according to an embodiment of the present disclosure.

FIG. 16a is a screenshot of the type listed legislation according to a query such as “blockchain.” FIG. 16b appears after a user clicks on the edit button. The system moves to a bills page where the user may then move to voting page by selecting the edit button. By clicking on the edit button in action column, the system moves to Bills data page on which administrator may view the bill details at left side and voting details on the right side of the page.

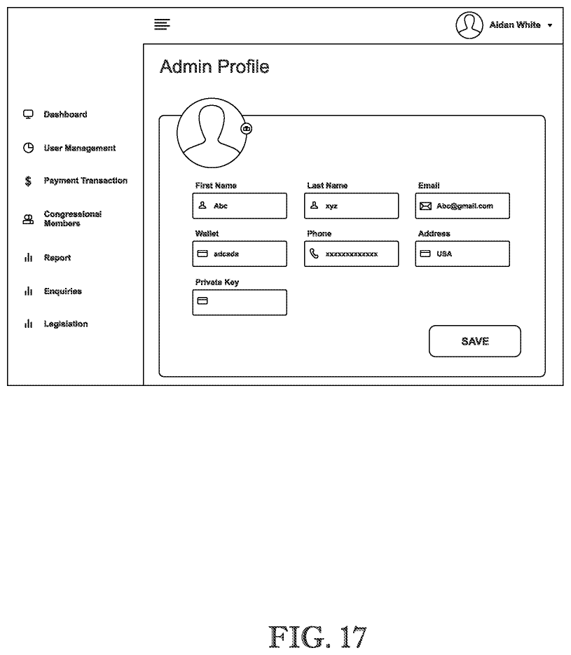

FIG. 17 is an image of a user screen of the application according to an embodiment of the present disclosure. FIG. 17 is an administrator profile interface. This interface is a dashboard for the administrator to display his/her profile including profile photo, First name, Last name, Email, Wallet Name, phone and address. Profiles may be updated through this user interface.

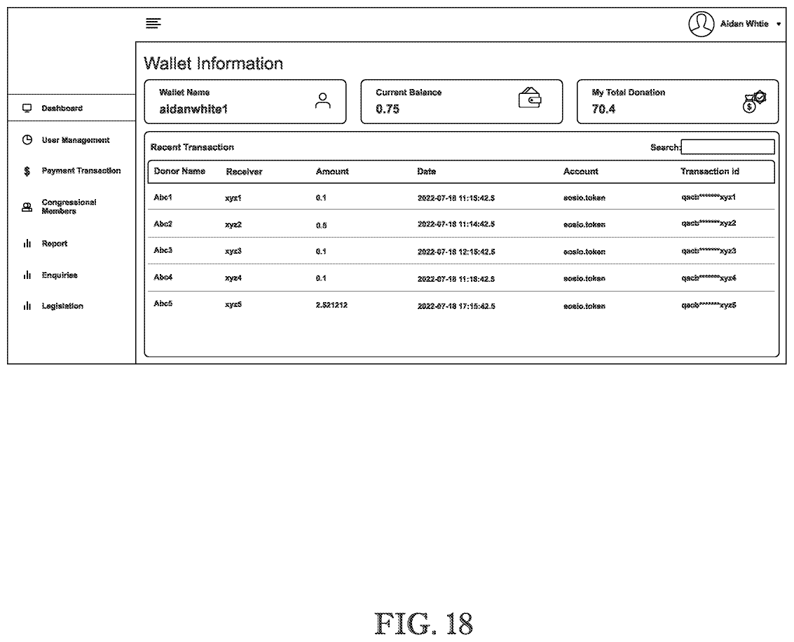

FIG. 18 is an image of a user screen of the application according to an embodiment of the present disclosure. FIG. 18 is a dashboard interface for user/donor. This interface is a dashboard for the donor page where a donor may view his/her previous transactions with details. The donor/user may view the wallet information at the top of the dashboard, for example wallet name, current balance, and total balance of the donor in EOS wallet.

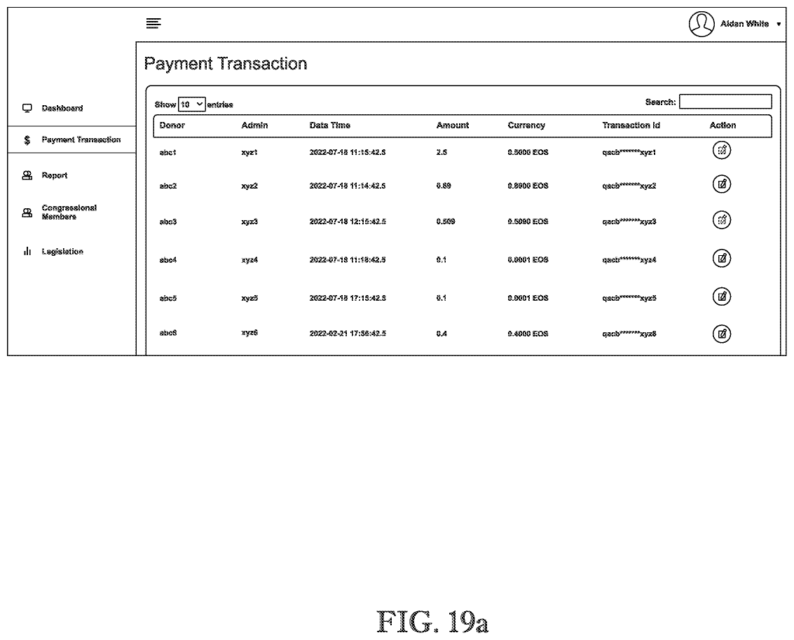

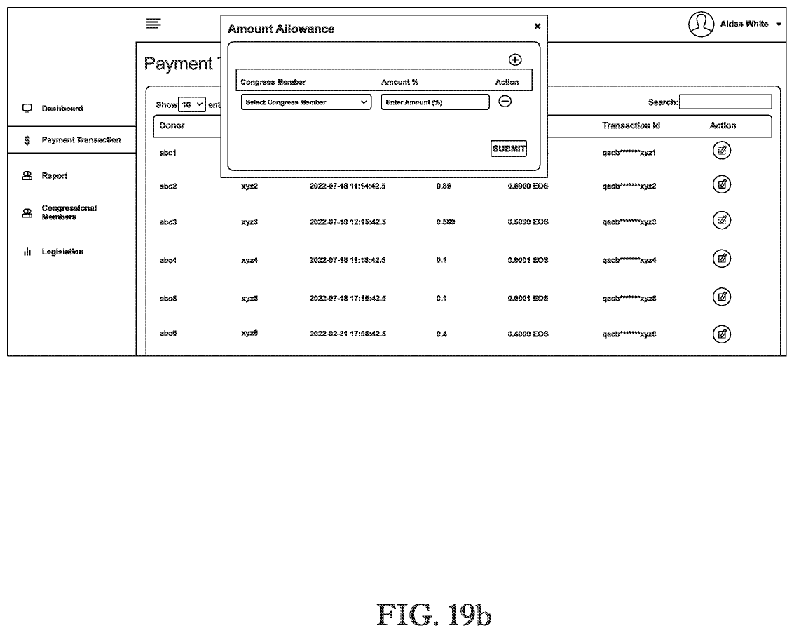

FIG. 19a and FIG. 19b are images of a combined user screen of the application according to an embodiment of the present disclosure. FIG. 19a and FIG. 19b together are a payment transaction interface for donors.

FIG. 19a is a dashboard interface for the donor page where the user may view his/her previous transactions with details. This interface will be used as a dashboard for the donor page where he/she may view previous transactions with details. FIG. 19b enables the donor to allocate portions of contributions to various legislators.

For the allocation, the donor completes the following steps:
a. The donor needs to edit the transaction.
b. After clicking on the edit button, a pop up will open
c. Select the legislator with their respective amount to allocate.
d. Donor can add more legislators by clicking on the plus (+) button and submit the same.
e. The system retains a percentage, for example 9%, of contributions donated to a legislator which is automatically calculated and deducted in a separate ledger utilized to maintain costs of the application.

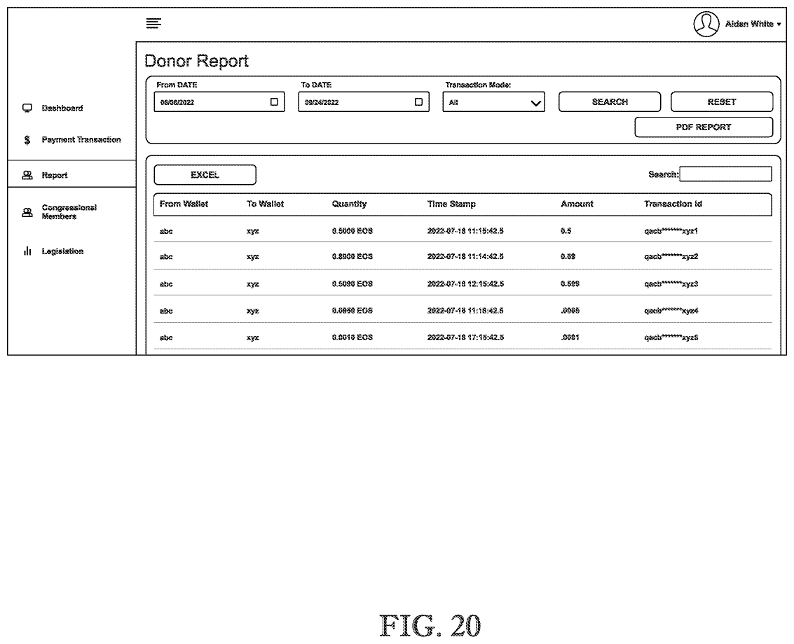

FIG. 20 is an image of a user screen of the application according to an embodiment of the present disclosure. FIG. 20 is a report interface for administrators. This screen may be used to fetch reports in PDF format as well as in Excel format. A donor may view the report data in data table basis on the filter, for example from Date′, To Date′ and ‘Transaction Mode.’

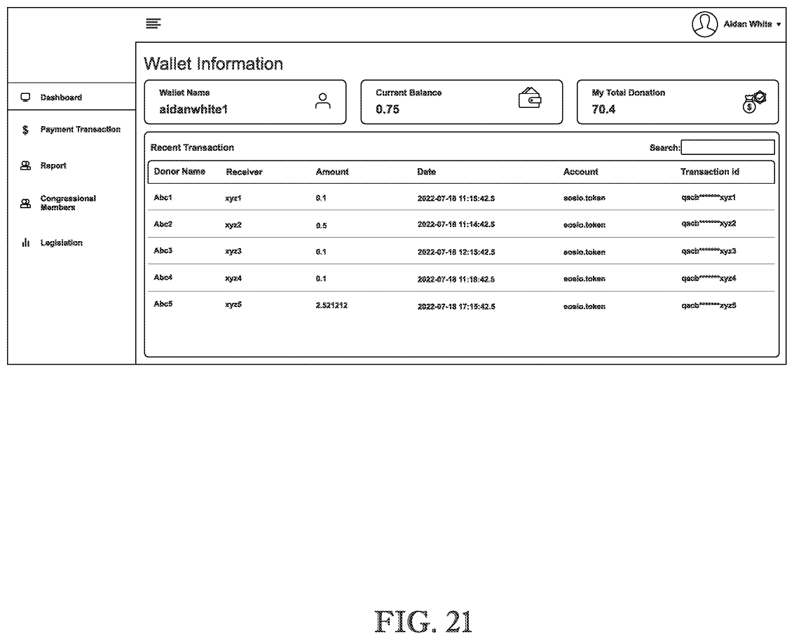

FIG. 21 is an image of a user screen of the application according to an embodiment of the present disclosure. FIG. 20 displays wallet information and is a dashboard for the donor to display his/her profile including profile photo, first name, last name, email address, wallet name, phone and address. The profile may be updated through this user interface.

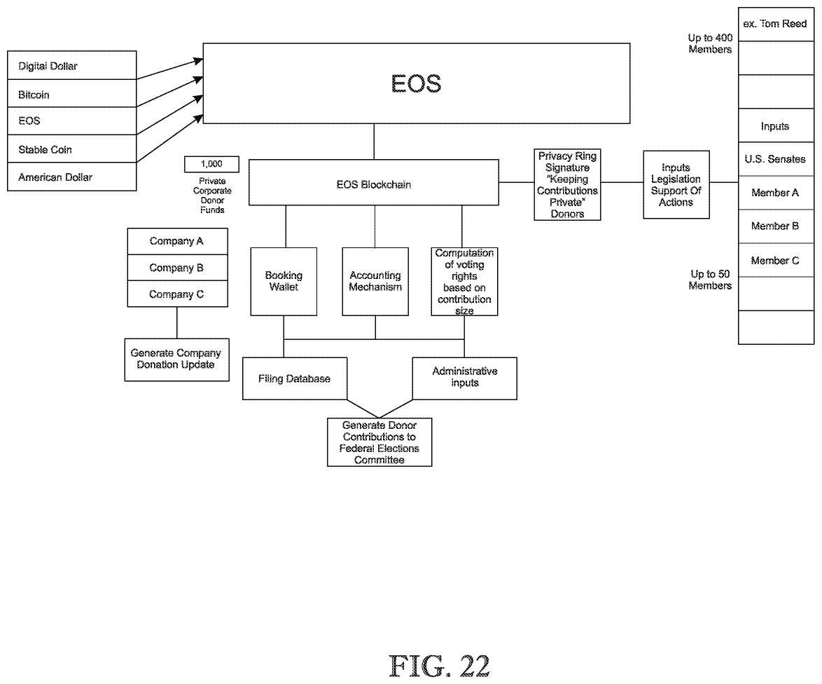

FIG. 22 is a flow diagram of the application according to an embodiment of the present disclosure. Contributions flow through the blockchain to legislators through a privacy ring structure.

Systems and methods described herein may in embodiments be stored in and execute on mobile devices. Many of the components of the system 100 may execute on mobile devices.

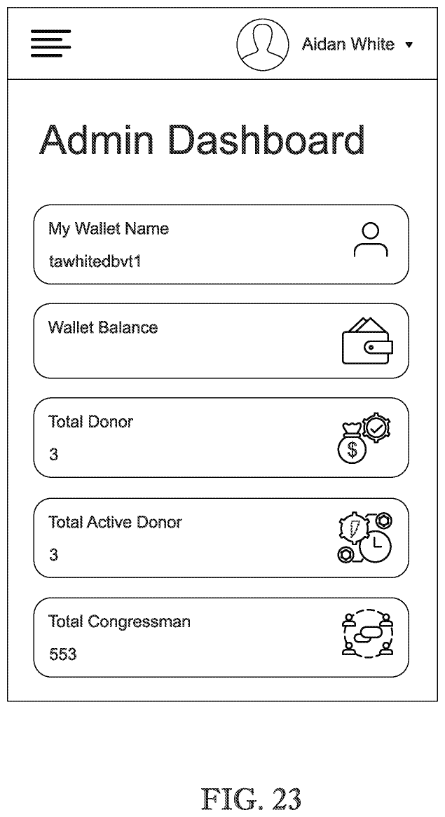

FIG. 23 is an image of a user screen of the application according to an embodiment of the present disclosure. FIG. 23 provides an image of a screen of a mobile device displaying a dashboard for the admin page from the mobile device where the administrator may view details of recent transactions. The admin may also view wallet information including wallet name, wallet balance, total donors, total active donors, total congress members, total paid amount, total received amount and total pending amount.

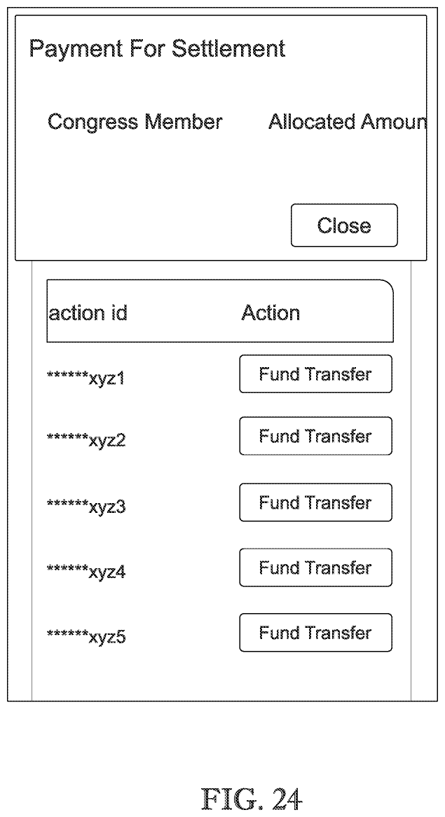

FIG. 24 is an image of a user screen of the application according to an embodiment of the present disclosure. FIG. 23 provides an image of a screen of a mobile device displaying payment for settlement. The portion of the application 104 shown in FIG. 23 is used on an administrator device to show the payment transactions of donors with wallet information of the donor including wallet name and transaction ID account of the blockchain. In the Payment Transaction tab, the administrator may view incoming and outgoing transactions separately by changing the drop-down menu to view options such as “Received Transaction” and “Outgoing Transaction.”

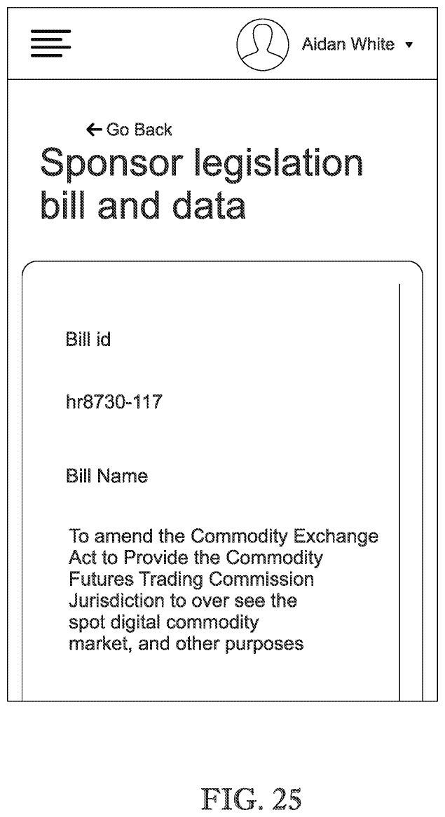

FIG. 25 is an image of a user screen of the application according to an embodiment of the present disclosure. FIG. 25 provides an image of a screen of a mobile device displaying sponsor legislation bill and data. By clicking on an edit button in action column page, the user is moved this screen in FIG. 25 that provides details about legislation of interest.

Systems and methods implement three REST API of Complycube for the AML/KYC verification in which the system 100 passes the First Name, Last Name, Email ID to verify the User from the Complycube. It returns the status of the User AML/KYC verification. Below are the steps.

Create a client—The first step in creating any check is to create a client from your backend server. A client can be a person or a company. For a person, a user must provide their first name and last name. Only the name is required for a company.

Create a check—Create a check by providing the Client ID and Check type. There are two types of AML Screening checks—Standard AML Screening and Extensive AML Screening. The example below uses Extensive AML Screening.

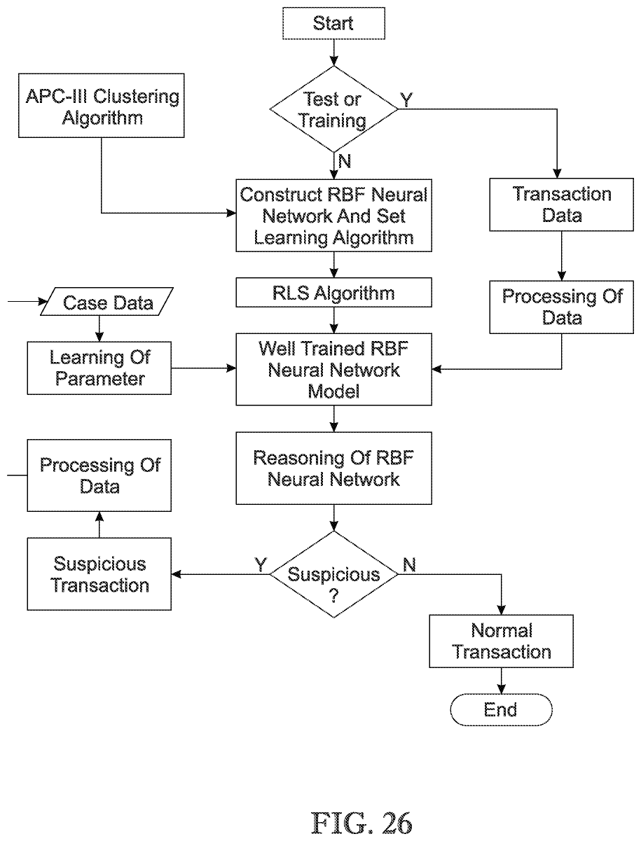

Perform check—Complycube will perform the check. A user may retrieve a check's outcome and breakdown via the API. The final response from the REST API is shown in FIG. 26.

For artificial intelligence, Cron jobs are a standard method of scheduling tasks to run on our server. Cron is a service running in the background that will execute commands (jobs) at a specified time, or at a regular interval. Jobs and their schedules are defined in a configuration file called a crontab. Systems and methods implement the Cron job to fetch the data updated data automatically such as congress member data list, Bills data, Legislation data, voting data into our system. Systems and methods schedule tasks which run in the background to store the updated data in servers at regular intervals of time. Associated information is reflected in the application 104.

In an embodiment, a digital blockchain voting technology system is provided comprising a computer and an application stored in the computer. When executed, the application receives a first message that an administrative wallet has received funds via a blockchain. The system also determines that the funds were sent by a donor wallet associated the blockchain. The system also receives a second message from a user device associated with the donor wallet, the second message requesting disbursement of the funds. The system also disburses the funds in accordance with an allocation formula provided by the user device.

The funds are directed, based on the allocation formula, to at least one legislative wallet associated with at least one legislator, the at least one legislative wallet associated with the blockchain. The allocation formula prescribes disbursements of the funds by stated percentages of the funds to stated legislators.

The stated legislators are associated with at least one item of legislation. The at least one item of legislation is of interest to at least one party associated with the donor wallet.

The system further provides functionality to determine legislators associated with individual items of legislation. The blockchain uses EOS.

The system is compliant with KYC/AML guidelines for blockchain transactions and political contributions. Funds submitted by donor wallets via the blockchain are recorded in the blockchain, the records at least used to generate reports required by government regulators.

In another embodiment, a method for receiving, recording, and disbursing political contributions via a blockchain is provided. The method comprises a computer receiving a request from a user device to identify legislators associated with a first item of legislation. The method also comprises the computer, after searching least a database, transmitting identification to the user device of the legislators of interest. The method also comprises the computer receiving notification of receipt by an administrator wallet of funds via a blockchain from a donor wallet associated with the user device. The method also comprises the computer disbursing the funds to legislator wallets of the legislators of interest according to an allocation directive provided by the user device.

The method also comprises the computer disbursing to each legislator wallet by percentages of the funds received from the donor wallet, the percentages described in the allocation directive. The method also comprises the computer implementing procedures to support compliance with KYC/AML guidelines for blockchain transactions, political contributions.

The method also comprises the computer recording funds submitted by donor wallets, the records at least used to generate reports required by government regulators. The method also comprises the computer identifying the legislators associated with the first item further comprises the computer determining legislators that voted one of for and against the first item.

In yet another embodiment, a system for supporting integrity of campaign funding is provided. The system comprises a computer and an application stored in the computer. When the application is executed, the system receives a first request to identify items of legislation and associated legislators in at least one legislature, the items associated with a first issue, the items further having been presented in the at least one legislature for at least one vote during a specified time period. The system also generates from searches of at least one data source for items of legislation associated with the first issue, a first list of the items. The system also generates a second list from the first list, the second list comprising items from the first list associated with legislatures of interest and time periods of interest. The system also transmits, in response to the first request, the second list, the second list further providing names of legislators associated with items of legislation described in the second list.

The first request is received from at least one user device associated with at least one donor wallet. The application receives notice of receipt in an administrator wallet associated with a blockchain of funds directed to the legislators named in the second list, the funds received from at the least one donor wallet via the blockchain.

The application directs the administrator wallet to disburse the funds to legislator wallets associated with the blockchain, the legislator wallets associated with the legislators named in the second list. The application records in the blockchain information comprising at least the items in the second list, the funds, and identities of parties associated with the at least one donor wallet. The application further generates from at least the blockchain, in response to a government requirement, a report describing at least the items in the second list, the funds, and identities of parties associated with the at least one donor wallet.

What is claimed is:

1. A digital blockchain voting technology system, comprising:
a computer; and
an application stored in the computer, that when executed:
receives a first message that an administrative wallet has received funds via a blockchain,
determines that the funds were sent by a donor wallet associated the blockchain,
receives a second message from a user device associated with the donor wallet, the second message requesting disbursement of the funds, and
disburses the funds in accordance with an allocation formula provided by the user device.

2. The system of claim 1, wherein the funds are directed, based on the allocation formula, to at least one legislative wallet associated with at least one legislator, the at least one legislative wallet associated with the blockchain.

3. The system of claim 1, wherein the allocation formula prescribes disbursements of the funds by stated percentages of the funds to stated legislators.

4. The system of claim 1, wherein the stated legislators are associated with at least one item of legislation.

5. The system of claim 4, wherein the at least one item of legislation is of interest to at least one party associated with the donor wallet.

6. The system of claim 1, wherein the system further provides functionality to determine legislators associated with individual items of legislation.

7. The system of claim 1, wherein the blockchain uses EOS

8. The system of claim 1, where the system is compliant with KYC/AML guidelines for blockchain transactions and political contributions.

9. The system of claim 1, wherein funds submitted by donor wallets via the blockchain are recorded in the blockchain, the records at least used to generate reports required by government regulators.

10. A method for receiving, recording, and disbursing political contributions via a blockchain, comprising:
a computer receiving a request from a user device to identify legislators associated with a first item of legislation;
the computer, after searching at least a database, transmitting identification to the user device of the legislators of interest;
the computer receiving notification of receipt by an administrator wallet of funds via a blockchain from a donor wallet associated with the user device; and
the computer disbursing the funds to legislator wallets of the legislators of interest according to an allocation directive provided by the user device.

11. The method of claim 10, further comprising the computer disbursing to each legislator wallet by percentages of the funds received from the donor wallet, the percentages described in the allocation directive.

12. The method of claim 10, further comprising the computer implementing procedures to support compliance with KYC/AML guidelines for blockchain transactions, political contributions.

13. The method of claim 10, further comprising the computer recording funds submitted by donor wallets, the records at least used to generate reports required by government regulators.

14. The method of claim 10, further comprising the computer identifying the legislators associated with the first item further comprises the computer determining legislators that voted one of for and against the first item.

15. A system for supporting integrity of campaign funding, comprising:
a computer; and
an application stored in the computer that when executed:
receives a first request to identify items of legislation and associated legislators in at least one legislature, the items associated with a first issue, the items further having been presented in the at least one legislature for at least one vote during a specified time period,
generates from searches of at least one data source for items of legislation associated with the first issue, a first list of the items,
generates a second list from the first list, the second list comprising items from the first list associated with legislatures of interest and time periods of interest, and
transmits, in response to the first request, the second list, the second list further providing names of legislators associated with items of legislation described in the second list.

16. The system of claim 15, wherein the first request is received from at least one user device associated with at least one donor wallet.

17. The system of claim 15, wherein the application receives notice of receipt in an administrator wallet associated with a blockchain of funds directed to the legislators named in the second list, the funds received from at the least one donor wallet via the blockchain.

18. The system of claim 17, wherein the application directs the administrator wallet to disburse the funds to legislator wallets associated with the blockchain, the legislator wallets associated with the legislators named in the second list.

19. The system of claim 15, wherein the application records in the blockchain information comprising at least the items in the second list, the funds, and identities of parties associated with the at least one donor wallet.

20. The system of claim 15, wherein the application further generates from at least the blockchain, in response to a government requirement, a report describing at least the items in the second list, the funds, and identities of parties associated with the at least one donor wallet.
